(19) United States
(12) Patent Application Publication
(10) Pub. No.: US 2020/0166771 A1
(43) Pub. Date: May 28, 2020

(54) Lens Driving Device With Optical Image Stabilization System

(71) Applicant: PowerGate Optical Inc., Zhubei City (TW)

(72) Inventors: Ying Chun Huang, Hsinchu City (TW); Yu Chia Chen, Hsinchu City (TW); Hsieh Jen Chuang, Hsinchu City (TW); Te Pao Ho, Hsinchu City (TW)

(73) Assignee: PowerGate Optical Inc., Zhubei City (TW)

(21) Appl. No.: 16/688,733

(22) Filed: Nov. 19, 2019

(30) Foreign Application Priority Data
Nov. 23, 2018 (TW) 107141926

(51) Int. Cl. G02B 27/64; H04N 5/232; G03B 5/02

(52) U.S. Cl. CPC G02B 27/646; G02B 7/09; G03B 5/02; H04N 5/23287

(57) ABSTRACT

A lens driving device having an OIS system comprises a movable part equipped with a lens, a fixed part and a driving system for moving the movable part to relative to the fixed part. A plurality of notches are furnished on a frame of the movable part. Each notch extends downward from an upper surface of the frame that, a bottom of the notch is the location where a damping medium is applied. A needle of a damper applying equipment can pass through the notch in a top-to-bottom manner and apply damping medium at the bottom of the notch. In addition, medium curing equipment can apply curing light directly from the top side of the lens driving device for curing the damping medium. Not only the operations for applying and curing the damping medium can be performed in a top-and-down manner and thus decreasing the manufacturing time, but also the placement of the production space between the production trays can be reduced and thus increasing the manufacturing batch.

### BACKGROUND OF INVENTION

### 1. Field of the Invention

The invention refers to a lens driving device, especially refers to a VCM lens driving device having AF and OIS system that can be applied with damping medium easily.

### 2. Description of the Prior Art

Lens driving devices equipped with OIS (optical image stabilization) system have the advantages of high reliability and high image resolution, and can provide clear and refined quality of images. Please refer to FIG. 1a which is an exploded perspective view of a basic structure of a typical lens driving devices 10 equipped with OIS system. The lens driving devices 10 generally comprises: a case 11, a movable part 12, a fixed part 13, a driving system 14 and an external circuit 92 having an image sensor 91.

The movable part 12 comprises: a frame 121, a lens support 123 equipped with a lens 1230, and at least one spring plate 1241, 1242 elastically connecting the frame 121 and the lens support 123 (including the lens 1230). The lens 1230 defines an optical axis 90.

The fixed part 13 comprises a base 133 and a connecting plate 132 and a circuit board 133 fixed on the base 133 in sequence.

For a lens driving device 10 equipped with AF (auto-focusing) and OIS systems, the driving system 14 usually comprises a first driving system 140a and a second driving system 140b, which are respectively furnished in the movable and fixed parts 12, 13. For example, the first driving system 140a is furnished between the frame 121 and the lens support 123 of the movable part 12 for driving the lens support 123 to move up-and-down relative to the frame 121 along the optical axis 90 (along Z-axis) in order to provide the AF function. The second driving system 140b is furnished between the circuit board 131 of the fixed part 13 and the frame 121 of the movable part 12 for driving the whole movable part 12 to move horizontally relative to the fixed part 13 along two horizontal directions (e.g., the X-axis and Y-axis) perpendicular to the optical axis 90 in order to provide the OIS function. For a lens driving device 10 using electric magnetic driving forces, both the first and second driving systems 140a, 140b comprise magnets and coils. In the embodiment shown in FIG. 1a, the first driving system 140a and the second driving system 140b are sharing the same magnets 141. However, in another embodiment not shown in figures, the first drive system 140a and the second drive system 140b may each have their own magnets, or some of the magnets are shared, but other magnets are used exclusively by either the first drive system 140a or the second drive system 140b.

In this embodiment, the first driving system 140a comprises: a plurality of magnetic components 141 (also referred as magnets 141) and a focusing coil 142. The magnets 141 are fixed in the receiving slots formed at the frame 121; the focusing coil 142 is wound around the outer circumference of the lens support 123 and is corresponding to the inner surfaces of the magnets 141. The second driving system 140b comprises: a plurality of horizontal coils 143 and the magnets 141. The horizontal coils 143 are furnished on the upper surface of the circuit board 131 and are respectively corresponding to the bottom surfaces of the magnets 141. In the first driving system 140a, by applying electric currents to the focusing coil 142 which is wound around the lens support 123 and is corresponding to the magnets 141, electric magnetic driving forces are generated to drive the lens support 123 together with the lens 1230 to move synchronously along the optical axis 90 in order to perform focusing operations of the lens 1230. The second driving system 140b shares the same magnets 141 which are corresponding to the horizontal coils 143 and the circuit board 131 along directions perpendicular to the optical axis 90; when the horizontal coils 143 are applied with electric currents, horizontal electric magnetic driving forces are generated to drive the movable part 12 to move along the directions parallel to the horizontal coils 143 in order to perform OIS operations of the lens 1230. In this embodiment, one or several position sensors 16 such like Hall sensors can be selectively furnished on either the circuit board 131 or connecting plate 132. These position sensors 16 are respectively corresponding to the bottom surfaces of the magnets 141 in order to detect either/both the position of the lens support 123 (together with the lens 1230 therein) relative to the fixed part 13 along the optical axis (Z-axis) or/and the position of the movable part 12 (together with the lens 1230 therein) relative to the fixed part 13 along the horizontal directions (X-axis and Y-axis), so as to provide closed-loop controls of the AF or/and OIS functions.

The plural suspension wires 15 constitute a suspension mechanism for suspending the movable part 12 above the fixed part 13. Each suspension wire 15 extends along the optical axis, having two ends thereof connected to the fixed part 13 and the movable part 12 respectively. The movable part 12 is supported and suspended above the fixed part 13 by the suspension wires 15 in such a manner that, the whole movable part 12 can perform limited horizontal displacements relative to the fixed part 13, but cannot move vertically. The suspension wires 15 provide both suspension and conduction features.

The frame 121 of the moving part 12 (together with the components therein) is elastically suspended on the circuit board 131 through the suspension wires 15 and is movable horizontally in a limited manner in any direction parallel to the plane of the image sensor 91, so as to compensate the displacements of tilt or jitter when taking pictures. The lens driving device 10 having OIS needs stable and precise control and feedback control during operations. However, when using the spring plates 1241, 1242 and suspension wires 15 to support the movable part, an oscillation phenomenon generated by resonance frequency will occur in the structure. Therefore, in the prior arts, damping medium such as damping gel will be applied on some components of the fixed part 13 (such like the horizontal coils 143, circuit board 131, connecting plate 132 or base 133) in order to connect some components of the moveable part 12 (such like the frame 121, magnets 141 or suspension wires 15). By means of the damping gel, the damping is increased, and the degree of relative shaking between the movable part 12 and the fixed part 13 is lowered, and thus the stability and precision of control and feedback control are improved.

Please refer to FIG. 1b, which is an assembled side view of the partially revealed inner structure of the lens driving devices 10 equipped with OIS system. As shown in FIG. 1b, by applying damping medium 99 (damping gel) to the connecting point of the lower end of suspension wire 15 and the circuit board 131, a part of the damping medium 99 sticks on the upper surface of either the horizontal coils 143, circuit board 131, connecting plate 132 or base 133 of the fixed part 13, while another part of the damping medium 99 sticks on the lower side of either the frame 121, magnets 141 or suspension wires 15 of the movable part 12. Because the gel-like damping medium 99 is viscous, the damping function between the movable part 12 and the fixed part 13 is achieved. Because the gap between the movable part 12 and the fixed part 13 is tiny, the processes to apply damping medium 99 to the tiny gaps between the movable part 12 and the fixed part 13 (or suspension wires 15) and to thicken the fluid-like damping medium 99 by using a curing device become very difficult. During batch production, a large area of operation space is required between the lens driving devices 10, thereby increasing the complexity of the process of batch production. In addition, the operations for applying and curing the damping medium 99 need to be performed at an oblique angle, not only more space and time are required for the processes, but also the productivity is lowered, and the costs are increased. Thereby, the lens driving devices equipped with OIS of the prior arts are difficult to be manufactured; their manufacturing processes are complex, laborious and costly, and thus are currently deployed in high-end flagship portable electronic products only, not popular in the various applications of the market, and unable to meet the needs of users at all levels for higher camera quality.

### SUMMARY OF THE INVENTION

The primary objective of the invention is to provide a lens driving device having OIS (optical image stabilization) system, which includes a novel structure providing a space for applying the damping medium, such that the processes of applying and curing damping medium can be performed in a top-to-bottom manner along a single axial direction parallel to the optical axis; not only the production time is decreased, but also the spacing between the production trays can be decreased so as to increase the batch size during the batch production, and thus the production costs are lowered. In order to improve the aforementioned deficiencies of the prior arts, the structure and driving systems of the lens driving device of the invention are creatively designed and configured in order to provide an optimization plan to simplify the manufacturing processes of its OIS and voice coil motor (VCM) systems.

Another objective of the invention is to provide a lens driving device having OIS system, which can maintain good linear horizontal pushing forces when the horizontal coils of the OIS system are applied with electric currents to drive the magnets to move away from the boundaries of the horizontal coils.

In order to achieve the aforementioned objectives, the invention provides a lens driving device with optical image stabilization system the lens driving device defines an optical axis and comprises: a fixed part; a movable part, which comprises a frame and a lens support located inside the frame; a suspension mechanism, for suspending the movable part above the fixed part in such a manner that, the movable part can perform limited displacements relative to the fixed part; and a driving system, for at least driving the frame of the movable part to move relative to the fixed part along a horizontal direction; said horizontal direction is perpendicular to the optical axis; wherein, the frame is furnished with at least one notch; the notch extends downward along the optical axis from an upper surface of the frame in such a manner that, a bottom of the notch is the location where a damping medium is applied, in addition, the damping medium attaches the movable part and one of the suspension mechanism and the fixed part.

In a preferred embodiment, a needle of a damper applying equipment can penetrate the notch in a top-to-bottom manner and then apply said damping medium at the bottom of the notch; in addition, a medium curing equipment can apply curing light directly from a top side of the lens driving device for curing the damping medium via the notch; a part of the damping medium connects the frame of the movable part, while another part of the damping medium connects either a circuit board or a base of the fixed part.

In a preferred embodiment, the fixed part comprises a base; the lens support is for holding a lens, said optical axis is defined by the lens; the lens support is received inside the lens support and is movable along the optical axis in a limited manner; the movable part further comprises at least one spring plate which elastically connects the frame and the lens support; the suspension mechanism comprises a plurality of suspension wires connecting between the base and the frame.

In a preferred embodiment, the lens driving device further defines an X-axis, a Y-axis and a Z-axis perpendicular with each other; the optical axis is parallel to the Z-axis; the X-axis and the Z-axis define a first axial surface; the Y-axis and the Z-axis define a second axial surface; the optical axis overlaps the Z-axis and is located on the intersection axis of the first and second axial planes; a direction of X-axis is called as a first direction; another direction of Y-axis is called as a second direction; the fixed part further comprises a circuit board and a connecting board; the circuit board is connectable with an external circuit via the connecting board; the external circuit is furnished with an image sensor; the driving system comprises: at least one focusing coil, at least two horizontal coils furnished on the circuit board, and a plurality of magnets furnished in the frame; wherein, the focusing coil is located on an outer periphery of the lens support and is corresponding to the magnets furnished in the frame; said horizontal coils are respectively corresponding to the magnets; the plurality of magnets are disposed along either the first direction or the second direction; for the magnet which is disposed along the first direction, a center point between two ends of the magnet is defined with a virtual plane which is parallel to the second axial plane; the virtual plane does not overlap with the second axial plane; among the plurality of magnets, at least two adjacent magnets are separated by a predetermined width which is larger than a width of the notch; the notch is formed on the frame and is located at the predetermined width.

In a preferred embodiment, the notch is located on the frame and is located at an end of the magnet disposed along the first direction; wherein, said end of the magnet where the notch is located is nearer to the second axial plane than the other end of the magnet.

In a preferred embodiment, the magnets disposed along the second direction are asymmetrically disposed on the left and right sides of the second axial plane across the lens.

In a preferred embodiment, when the magnets disposed along the first direction are virtually divided into two parts along the virtual plane, the volumes of these two divided parts will be different, in which, the part near to the second axial plane is smaller than the other part away from the second axial plane.

In a preferred embodiment, when viewing a sectional view parallel to the first axial plane, a length of a bottom edge of the magnet disposed along the first direction is larger than a length of a top edge of the same magnet away from the horizontal coil; in addition, the magnet is formed with an extending portion at an end nearby the notch; the extending portion of the magnet and the notch of the frame are partially overlapped in such a manner that, the damping medium applied at the bottom of the notch can connect to both the extending portion of the magnet and the circuit board.

In a preferred embodiment, a width of the notch along the first direction and another width of the notch along the second direction are both larger than 0.3 mm and smaller than 0.8 mm; the predetermined width where said at least two adjacent magnets are separated is larger than 0.8 mm and smaller than 3 mm.

In a preferred embodiment, the damping medium is connecting a bottom surface of the frame and the circuit board.

In a preferred embodiment, a protrude is formed at a bottom side of the lens support and is extending into the bottom of the notch; the applied damping medium is attaching the protrude of the lens support and the circuit board.

In a preferred embodiment, at least one of the suspension wires is extending inside the notch along a direction parallel to the Z-axis; a groove is formed at the bottom of the notch of the frame; the groove is formed with a through hole to allow the suspension wire to pass through; the damping medium is applied at the groove of the notch in such a manner that, a portion of the damping medium attaches to a lower portion of the suspension wire, while another portion of the damping medium attaches to the groove.

In a preferred embodiment, a gap between the focusing coil and the magnet disposed along the second direction is larger than another gap between the focusing coil and the magnet disposed along the first direction.

In a preferred embodiment, when viewing a projection of the magnet along the Z-axis direction, a thickness in the Y-axis direction of the magnet will change along the X-axis direction; therefore, even when a current is applied to the horizontal coil to drive the magnet to move along the Y-axis direction, and to result that a projection of a portion of the volume of the magnet in the Z-axis direction is shifted away from a range of the horizontal coil, a linear performance of horizontal driving force can still be maintained.

### BRIEF DESCRIPTION OF THE DRAWINGS

FIG. 1a is an exploded perspective view of a basic structure of a typical lens driving devices 10 equipped with OIS system;

FIG. 1b is an assembled side view of the partially revealed inner structure of the lens driving devices 10 equipped with OIS system;

FIGS. 2a-2e respectively are a schematic side-view (applying the damping medium), another schematic side-view (curing the damping medium), a schematic perspective view (applying the damping medium), a schematic diagram of the driving system, and a schematic top-view of the configuration of magnets of a first embodiment of the lens driving device with OIS system in accordance with the present invention;

FIG. 3a and FIG. 3b respectively are the schematic top views of the second and the third embodiments of the lens driving device with OIS system in accordance with the invention, in which, configuration of the magnets is schematically shown;

FIG. 4a and FIG. 4b respectively are the schematic top views of the fourth and the fifth embodiments of the lens driving device with OIS system in accordance with the invention, in which, configuration of the magnets is schematically shown;

FIG. 4c is the schematic sectional view of the sixth embodiment of the lens driving device with OIS system in accordance with the invention;

FIG. 4d is the schematic sectional view of the seventh embodiment of the lens driving device with OIS system in accordance with the invention;

FIG. 5a and FIG. 5b respectively are the schematic top views (overlooking along the optical axis) of two different embodiments of the magnet of the lens driving device with OIS system in accordance with the invention;

FIG. 6a is a schematic perspective view (applying the damping medium) of the eighth embodiment of the lens driving device with OIS system in accordance with the present invention;

FIG. 6b is a schematic top view of the ninth embodiment of the lens driving device with OIS system in accordance with the present invention, in which, configuration of the magnets is schematically shown;

FIG. 6c is a schematic top view of the tenth embodiment of the lens driving device with OIS system in accordance with the present invention, in which, configuration of the magnets is schematically shown;

FIG. 7 is a schematic perspective view (applying the damping medium) of the eleventh embodiment of the lens driving device with OIS system in accordance with the present invention.

### DESCRIPTION OF THE PREFERRED EMBODIMENT

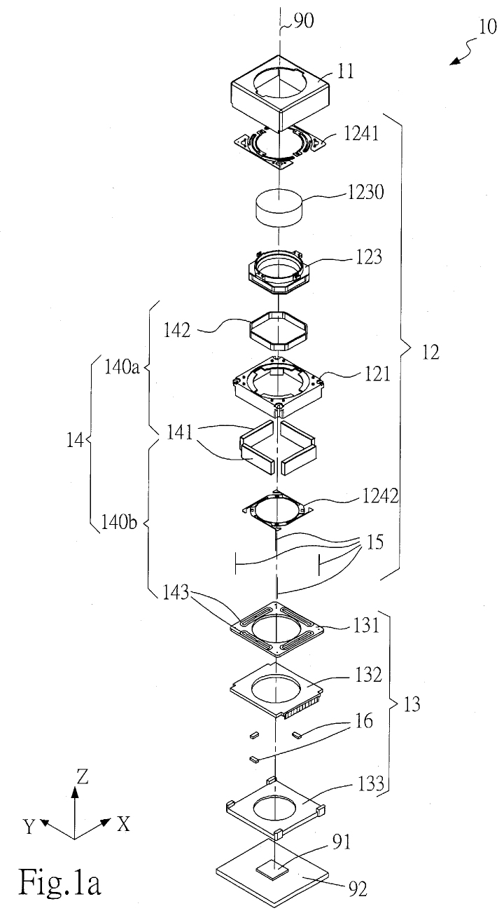

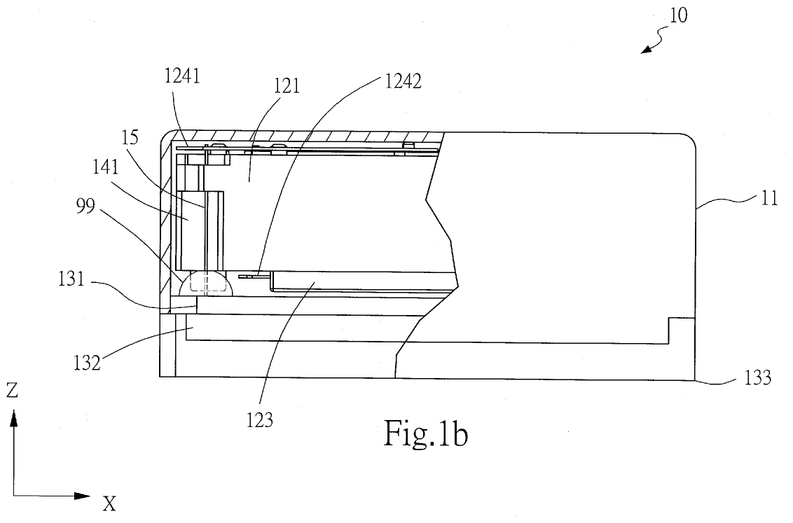

In order to describe the lens driving device with optical image stabilization system of the invention in detail, figures or drawings are introduced accompanying the descriptions below. Because the basic structure of the lens driving device with optical image stabilization system of the invention is similar with the typical lens driving devices 10 equipped with OIS system shown in FIG. 1a, thereby, in the following description, same or similar components will be directly assigned with the same component names and numerals without illustrating their detail structures and features in such a manner that, only the novel structures and/or features of the lens driving device with optical image stabilization system of the invention will be described in detail. That means, the basic structure of the lens driving device with optical image stabilization system of the invention also comprises the following components as shown in FIG. 1a: a case 11, a movable part 12, a fixed part 13, a driving system 14 and an external circuit 92 having an image sensor 91. Wherein, the movable part 12 also comprises: a frame 121, a lens support 123 equipped with a lens 1230, and at least one spring plate 1241, 1242 connecting the frame 121 and the lens support 123 (including the lens 1230). The lens 1230 defines an optical axis 90. In addition, the fixed part 13 comprises a base 133 and a connecting plate 132 and a circuit board 133 fixed on the base 133 in sequence.

In the present invention, similar with the basic structure shown in FIG. 1a, the driving system 14 of the lens driving device 10a with optical image stabilization system also comprises a first driving system 140a and a second driving system 140b, which are respectively furnished in the movable and fixed parts 12, 13. In this embodiment, the first driving system 140a is furnished between the frame 121 and the lens support 123 of the movable part 12 for driving the lens support 123 to move up-and-down relative to the frame 121 along the optical axis 90 (along Z-axis) in order to provide the auto-focusing (AF) function. The second driving system 140b is furnished between the circuit board 131 of the fixed part 13 and the frame 121 of the movable part 12 for driving the whole movable part 12 to move horizontally relative to the fixed part 13 along two horizontal directions (e.g., the X-axis and Y-axis) perpendicular to the optical axis 90 in order to provide the OIS function. For a lens driving device 10 using electric magnetic driving forces, both the first and second driving systems 140a, 140b comprise magnets and coils. In the embodiment shown in FIG. 1a, the first driving system 140a and the second driving system 140b are sharing the same magnets 141. However, in another embodiment not shown in figures, the first drive system 140a and the second drive system 140b may each have their own magnets, or some of the magnets are shared, but other magnets are used exclusively by either the first drive system 140a or the second drive system 140b

In this embodiment, the first driving system 140a of the lens driving device 10a of the invention also comprises: a plurality of magnetic components 141 (also referred as magnets 141) and a focusing coil 142. The magnets 141 are mounted in the receiving slots formed at the frame 121; the focusing coil 142 is wound around the outer circumference of the lens support 123 and is corresponding to the inner surfaces of the magnets 141. The second driving system 140b comprises: a plurality of horizontal coils 143 and the magnets 141. The horizontal coils 143 are furnished on the upper surface of the circuit board 131 and are respectively corresponding to the bottom surfaces of the magnets 141. In the first driving system 140a, by applying electric currents to the focusing coil 142 which is wound around the lens support 123 and is corresponding to the magnets 141, electric magnetic driving forces are generated to drive the lens support 123 together with the lens 1230 to move synchronously along the optical axis 90 in order to perform focusing operations of the lens 1230. The second driving system 140b shares the same magnets 141 which are corresponding to the horizontal coils 143 and the circuit board 131 along directions perpendicular to the optical axis 90; when the horizontal coils 143 are applied with electric currents, horizontal electric magnetic driving forces are generated to drive the movable part 12 to move along the directions parallel to the horizontal coils 143 in order to perform OIS operations of the lens 1230. In this embodiment, one or several position sensors 16 such like Hall sensors can be selectively furnished on either the circuit board 131 or connecting plate 132. These position sensors 16 are respectively corresponding to the bottom surfaces of the magnets 141 in order to detect either/both the position of the lens support 123 (together with the lens 1230 therein) relative to the fixed part 13 along the optical axis (Z-axis) or/and the position of the movable part 12 (together with the lens 1230 therein) relative to the fixed part 13 along the horizontal directions (X-axis and Y-axis), so as to provide closed-loop controls of the AF or/and OIS functions.

The plural suspension wires 15 constitute a suspension mechanism for suspending the movable part 12 above the fixed part 13. Each suspension wire 15 extends along the optical axis, having two ends thereof connected to the fixed part 13 and the movable part 12 respectively. The movable part 12 is supported and suspended above the fixed part 13 by the suspension wires 15 in such a manner that, the whole movable part 12 can perform limited horizontal displacements relative to the fixed part 13, but cannot move vertically. The suspension wires 15 provide both suspension and conduction features. The frame 121 of the moving part 12 (together with the components therein) is elastically suspended on the circuit board 131 through the suspension wires 15 and is movable horizontally in a limited manner in any direction parallel to the plane of the image sensor 91, so as to compensate the displacements of tilt or jitter when taking pictures. In the meantime, these suspension wires 15 also electrically connect the focusing coil 142 with the circuit board 131, in order to provide the function of transmitting electric signals between the circuit board 131 and the focusing coil 142 via the suspension wires 15 and the spring plates 1241, 1242. Because there is a trend toward miniaturization in structural design of the lens driving device with OIS system suitable for being furnished in the smart phones, the maximum width in the horizontal directions of the X-axis and the Y-axis is usually only about 6-12 mm, and the maximum height in the Z-axis direction is only between 2-5 mm; therefore, the miniaturized parts inside the lens driving device are not only small in size, but also have a small distance between the parts, which makes it very difficult to perform the process of applying the damping medium for the typical lens driving device 10 shown in FIG. 1a.

In order to resolve the aforementioned difficulty, the lens driving device with OIS system of the invention comprises a plurality of notches are furnished on a frame of the movable part. Each notch is extending downward (along Z-axis) from an upper surface of the frame in such a manner that, a bottom of the notch is the location where a damping medium is applied. Therefore, a needle of a damper applying equipment can conveniently penetrate the notch in a top-to-bottom manner and then apply damping medium at the bottom of the notch directly. In addition, medium curing equipment can also apply curing light directly from the top side of the lens driving device for curing the damping medium. Not only the operations for applying and curing the damping medium can be performed along a single axial direction (Z-axis direction) in a top-and-down manner and thus the manufacturing time can be decreased, but also the placement of the production space between the production trays can be reduced and thus the manufacturing batch size can be increased.

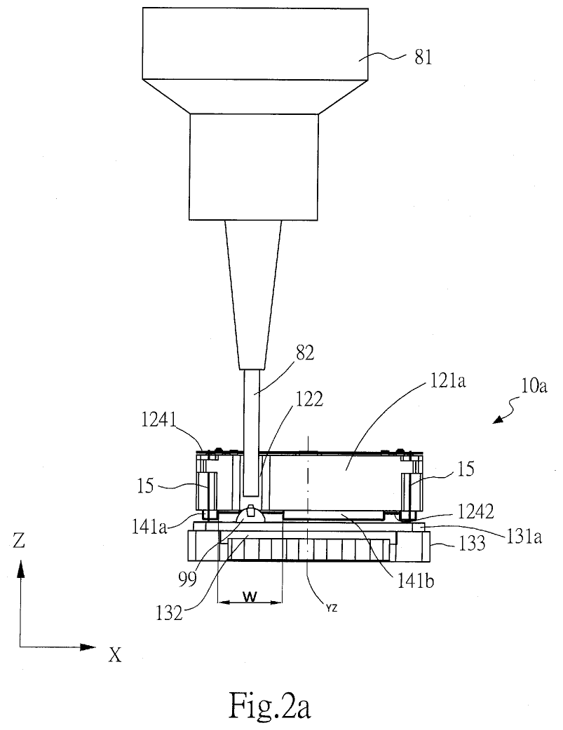

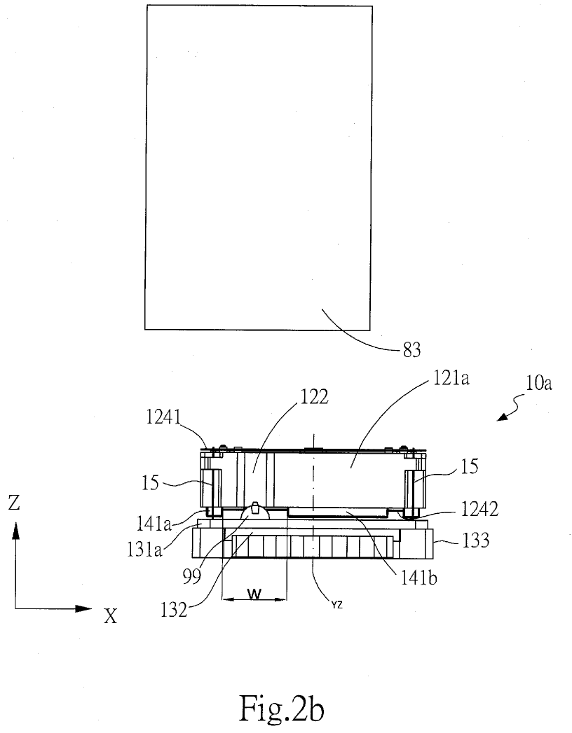

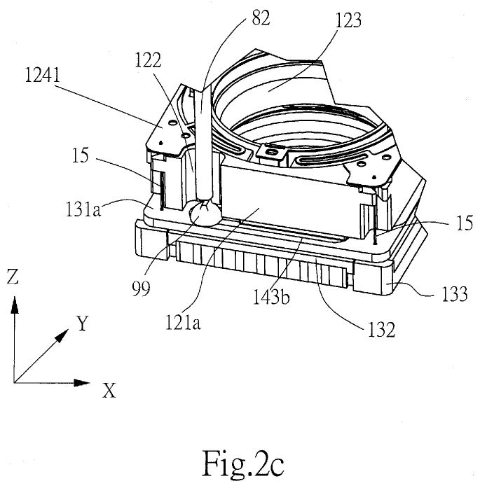

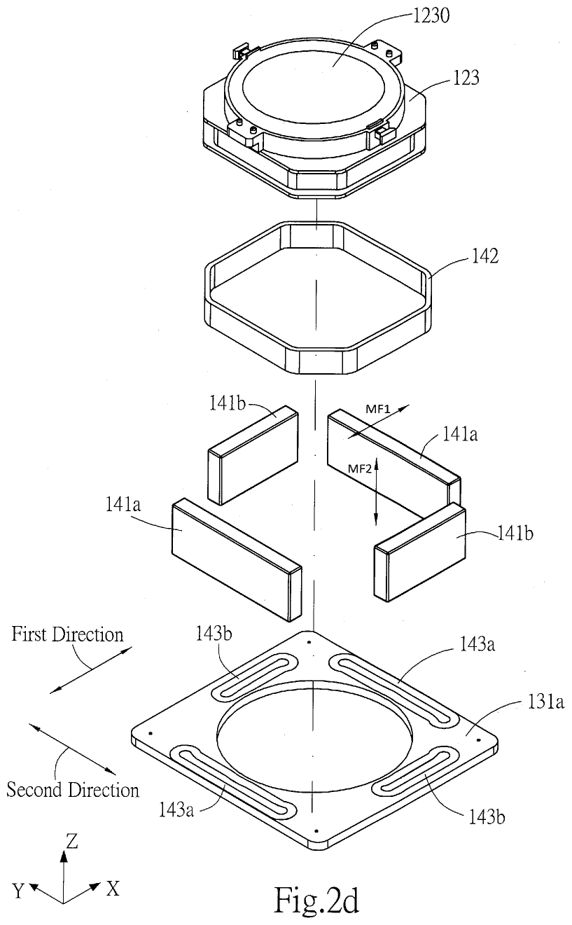

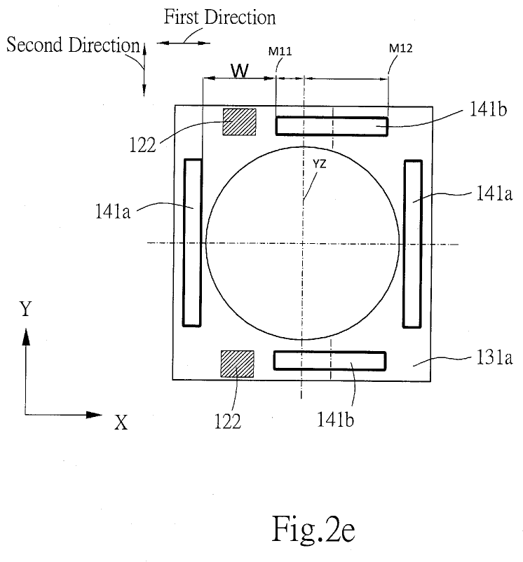

Please refer to FIGS. 2a-2e, which respectively are a schematic side-view (applying the damping medium), another schematic side-view (curing the damping medium), a schematic perspective view (applying the damping medium), a schematic diagram of the driving system, and a schematic top-view of the configuration of magnets of a first embodiment of the lens driving device with OIS system in accordance with the present invention. In order to improve the convenience of the operation of applying the damping medium 99, and to reduce the spacing between the production trays of lens driving devices 10a so as to increase the batch size during the batch production, the lens driving device 10a with OIS system of the invention is specially designed to comprise a plurality of notches 122 furnished on a frame 121a of the movable part. Each notch 122 is extending downward (along Z-axis) from an upper surface of the frame 121a in such a manner that, a bottom of the notch 122 is the location where a damping medium 99 is applied. When observing from a side perpendicular to the optical axis, as shown in FIG. 2a and FIG. 2c, there is a width W between two adjacent magnets 141a, 141b of the lens driving device 10a of the invention. The frame 121a at least comprises a notch 122 (also referred as notch S) which is extending up-to-down and is located at the width W between the two neighboring magnets 141a, 141b. The width W is larger than the width of the notch 122 in the horizontal direction, in addition, the width of the notch 122 in the horizontal direction is larger than the outer diameter of the elongated needle 82 of the damper applying equipment 81. During the manufacturing processes of the lens driving device 10a, damping medium 99 is applied through the configuration of the notch 122 (notch S) of the frame 121a to connect the bottom surface of frame 121a and any component of the fixed part 13 (for example, but not limited to, the top surface of the circuit board 131a), so as to stabilize the lens driving device 10a rapidly. The elongated needle 82 of the damper applying equipment 81 can conveniently penetrate the notch 122 of the frame 10a along a direction parallel to the optical axis (the Z-axis) in a top-to-bottom manner and then apply damping medium 99 at the bottom of the notch 122 directly, such that a part of the applied damping medium 99 sticks on (connects) the bottom surface of the frame 121a of the movable part, while another part of the applied damping medium 99 sticks on (connects) the top surface of the circuit board 131a of the fixed part. And then, as shown in FIG. 2b, the design and configuration of these notches 122 of the frame 121a of the lens driving device 10a also allow the medium curing equipment 83 to emit curing light from the top side of the frame 121a, and the emitted curing light can directly pass through the notch 122 in a top-to-bottom manner and reach the damping medium 99 located at the bottom end of the notch 122, such that, the amount of curing light reaches the damping medium 99 during the curing (thickening) process can be increased. Therefore, the problems of insufficient curing of damping medium, longer time required for curing process and unstable control of power consumption caused by the miniaturized components of lens driving device and obscured curing light during the curing process can all be improved.

The lens driving device 10a with OIS system of the invention defines axial planes perpendicular to each other, as shown in FIG. 2a (also referring to FIG. 1a), which comprise: a first axial plane (XZ), a second axial plane (YZ) and an optical axis (Z-axis) located on the intersection axis of these two axial planes. More specifically speaking, the lens driving device 10a of the invention defines an X-axis, a Y-axis and a Z-axis perpendicular to each other. The optical axis is overlapped with the Z-axis. The first axial plane (XZ) is defined by the X-axis and the Z-axis. The second axial plane (YZ) is defined by the Y-axis and the Z-axis. The optical axis is located at the intersection axis of these two axial planes (XZ and YZ) and is the Z-axis. The X-axis is also referred as the first direction, and the Y-axis is also referred as the second direction. In the embodiment shown in FIG. 2a, the lens driving device 10a comprises: a lens support 123 (holding a lens therein), a frame 121a, at least one spring plate 1241, 1242, an electromagnetic driving system, a plurality of suspension wires 15, a circuit board 131a, a connecting plate 132, a base 133 and a case.

The case has a through hole. The frame 121a is located within the case and forms an inner compartment therein. The lens support 123 together with the lens are furnished inside the inner compartment of the frame 121a. The spring plates (including an upper spring plate 1241 and a lower spring plate 1242) are connected at the upper and bottom ends of the frame 121a respectively in order to constrain the lens support 123 together with the lens to move along the optical axis inside the inner compartment. The frame 121a further includes at least one notch 122 extending from the top surface of the frame downward toward the bottom surface of the frame 121a, which provides an operation space for applying and curing the damping medium.

As shown in FIG. 2d, the driving system of the invention comprises: at least one focusing coil 142, at least two horizontal coils 143a, 143b and a plurality of magnetic components 141a, 141b (also referred as magnets 141a, 141b). Wherein, the focusing coil 142 is wound around the outer circumference of the lens support 123 (which is holding the lens 1230) and is corresponding to the inner surfaces of the magnets 141, in order to provide the driving forces along the Z-axis to act as the AF (auto-focusing) driving device. The magnets 141a, 141b are respectively located different sides of the frame 121a in such a manner that, each one of the magnets 141a, 141b has its own length direction to be parallel to either the first direction (X-axis direction) or the second direction (Y-axis direction). The horizontal coils 143a, 143b are furnished on the top surface of the circuit board 131a and are respectively corresponding to the bottom surfaces of the magnets 141a, 141b, in order to provide the horizontal driving forces along the horizontal directions (that is, X-axis and Y-axis directions) perpendicular to the optical axis to act as the OIS driving device. Please refer to FIG. 2d, the polar directions MF1 of magnets 141a, 141b have the same polarity facing toward the focusing coil 142 which is wound around the outer periphery of the lens (lens support); the vertical polar directions MF2 of magnets 141a, 141b are perpendicular with the horizontal coils. The focusing coil can be either a ring-typed monopole coil, a ring-typed bipolar coil or a printed circuit board (PCB) furnished with coil circuits.

The horizontal coils 143a, 143b, circuit board 131a and connecting board 132 are respectively located above the base 133 to form the fixed part 13. Please refer to FIGS. 2a-2d and FIG. 1a, the connecting board 132 is electrically connected with both the circuit board 131a and an external circuit 92. The external circuit 92 is located under the frame 131a and the base 133, and is furnished with an image sensor 91. At least one position sensor 16 (such as Hall sensor) can be selectively furnished on the circuit board 131a, connecting board 132 or external circuit 133, and is corresponding to the bottom surface of the magnet 141a, 141b positioned along the first direction (X-axis direction) or second direction (Y-Axis direction). The suspension wires 15 provide both suspension and conduction features. The frame 121a, lens support 123 (together with lens 1230) and the spring plates 1241, 1242 are suspended together above the circuit board 131a by the suspension wires 15.

Please refer to FIG. 2e, which shows a schematic top view of the first embodiment of the lens driving device 10a with OIS system in accordance with the present invention, in which, the configuration of the magnets 141a, 141b is schematically presented. The magnets 141a, 141b mounted in the frame 131a are located at the outer periphery of the focusing coil and can be divided into two pairs. Each pair of magnets 141a (or magnets 141b) includes two magnets 141a (or magnets 141b) located at opposite sides of the lens. When viewing along the optical axis (Z-axis), the configuration of magnets 141a, 141b of the lens driving device 10a with OIS system of the invention have the following characteristics: the length direction of each one of the magnets 141a, 141b is parallel to either the first direction or the second direction (that is, the length direction of each one of the magnets 141a, 141b is extending along either the first direction or the second direction). At least two adjacent magnets 141a, 141b are separated by a predetermined width W. For the magnets 141b which are located and extending along the first direction, the center point between two ends in the length direction of each magnet 141b is defined with a virtual plane which is parallel to the second axial plane (YZ). The virtual plane does not overlap with the second axial plane (YZ). The notch 122 is formed on the frame 131a and is located at the predetermined width W. The width W between the two adjacent magnets 141a, 141b is larger than the width of the notch 122 formed on the frame 131a. That is, the notch 122 is located on the frame 131a and is located at an end of the magnet 141b disposed along the first direction; wherein, said end where the notch 122 is located is nearer to the second axial plane (YZ) than the other end of the magnet 141. More specifically speaking, the distances (M11 and M12) between the second axial plane (YZ) and two ends of the magnet 141b disposed along the first direction are different, in which, M11 is shorter than M12. Which means, the center point of the magnet 141b disposed along the first direction is not located at the second axial plane (YZ), and is displaced away from the notch 122 toward right side by a predetermined distance, so as to leave a gap (that is, the predetermined width W) at the end where the magnet 141b is near to the notch 122 to furnish the notch 122. Thereby, the distance between the end where the magnet 141b is near to the notch 122 and the inner side of another adjacent magnet 141a is equal to the predetermined width W. By means of the displacement of the magnet 141b, that is, to allow the magnet 141b disposed along the first direction to be displaced toward right side, the frame 131a of the lens driving device 10a can have sufficient width W to furnish the notch 122, for conducting the applying and curing processes of the damping medium.

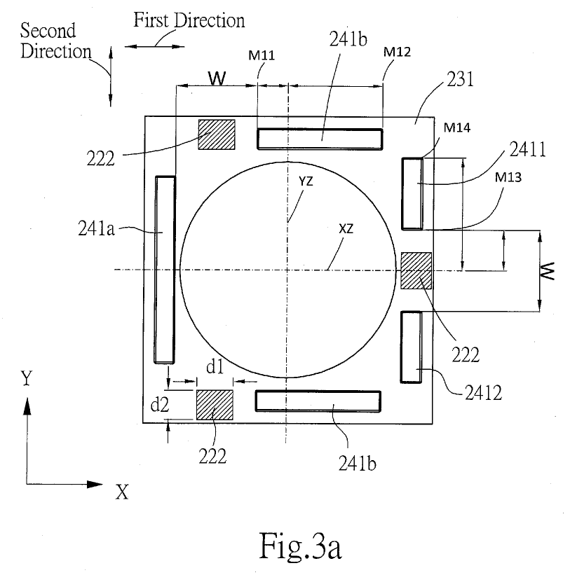

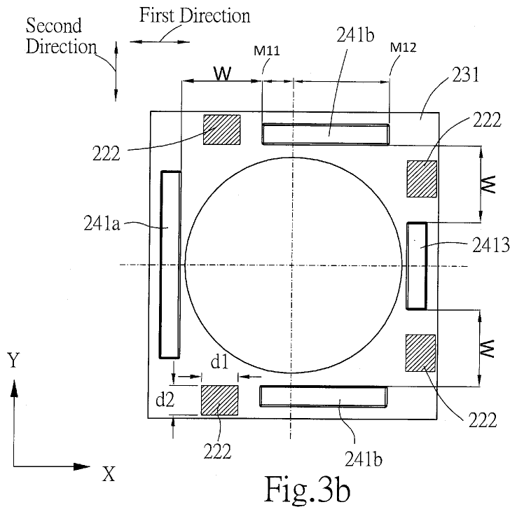

Please refer to FIG. 3a and FIG. 3b, which respectively are the schematic top views of the second and the third embodiments of the lens driving device with OIS system in accordance with the invention, in which, configuration of the magnets is schematically shown. The characteristic of the second embodiment of lens driving device with OIS system in accordance with the invention as shown in FIG. 3a is that, the magnets 241a, 241b, 2411, 2412 mounted in the frame comprise: the distances (M11 and M12) between the second axial plane (YZ) and two ends of the magnet 241b disposed along the first direction are different, in which, M11 is shorter than M12. Which means, the center point of the magnet 241b disposed along the first direction is not located at the second axial plane (YZ), and is displaced away from the notch 222 toward right side by a predetermined distance, so as to leave a gap (that is, the predetermined width W) at the end where the magnet 241b is near to the notch 222 to furnish the notch 222. The distance between the left end of the magnet 241b and another magnet 241a disposed at left side of the magnet 241b is the predetermined width W, and the notch 222 is formed at the area of width W. Moreover, the magnets 241a, 2411, 2412 disposed along the second direction are asymmetrically disposed on the left and right sides of the second axial plane (YZ) across the lens. In which, the distances between the first axial plane (XZ) and the lower and upper ends of the two magnet 2411, 2412 located on the right side of the circuit board 231 are different, in which, M13 is shorter than M14. That is, the center points of the two magnets 2411, 2412 located on the right side of the circuit board 231 and disposed along the second direction (Y-axis direction) are respectively displaced upward and downward for a predetermined distance, in order to leave a gap (width W) between these two magnet 2411, 2412 for furnishing the notch 222. By means of the displaced magnets 241b, 2411 and 2412, the frame of the lens driving device can have sufficient spaces to accommodate a plurality of notches 222 for conducting the applying and curing processes of the damping medium. In a preferred embodiment of the invention, the width W is preferably larger than 0.8 mm and smaller than 3 mm. The width d1 of the notch 222 along the first direction (X-axis direction) and the width d2 of the notch 222 along the second direction (Y-axis direction) are both slightly larger than the outer diameter of the elongated needle 82 of the damper applying equipment 81, in order to allow the needle 82 to pass through the notch 222 from the top end thereof and apply the damping medium 99 at the bottom end of the notch 222, and to allow the applied damping medium 99 to stick on both the bottom surface of the frame and the top surface of the circuit board. However, on the other hand, both the width d1 and the width d2 should not be too large, so as not to affect the size and configuration of the magnet 241b. In this embodiment, the width d1 and the width d2 are both preferably larger than 0.3 mm and smaller than 0.8 mm.

The characteristic of the third embodiment of lens driving device with OIS system in accordance with the invention as shown in FIG. 3b is that, the magnets 241a, 241b, 2413 mounted in the frame comprise: the distances (M11 and M12) between the second axial plane (YZ) and two ends of the magnet 241b disposed along the first direction (X-axis direction) are different, in which, M11 is shorter than M12. Which means, the center point of the magnet 241b disposed along the first direction is not located at the second axial plane (YZ), and is displaced toward right side by a predetermined distance, so as to leave a gap (that is, the predetermined width W) at the left end of the magnet 241b. The distance between the left end of the magnet 241b and another magnet 241a disposed at left side of the magnet 241b is the predetermined width W, and the notch 222 is formed at the area of width W. Moreover, the magnets 241a, 2413 disposed along the second direction are asymmetrically disposed on the left and right sides of the second axial plane (YZ) across the lens. In which, the length of the magnet 2413 at right side along its longitudinal direction (Y-axis direction) is smaller than the length of the other magnet 241a at opposite side (left side), such that the distances between the inner surfaces of the two magnets 241b disposed along the first direction and the two ends (upper and lower ends) of the magnets 2413 disposed along the second direction (Y-axis direction) are both the width W, so as to furnish the notches 222 at the area of the width W. Which means, the length along the Y-axis direction of the magnet 2413 located at the right side of the circuit board is smaller than the other magnet 241a disposed opposite to the magnet 2413, and notches 222 are respectively disposed at each of the upper and lower ends of the magnet 2413. By means of the displaced magnets 241b, 2413, the frame of the lens driving device can have sufficient spaces to accommodate a plurality of notches 222 for conducting the applying and curing processes of the damping medium. More importantly, in this embodiment of the invention, the magnets 241b disposed along the first direction are offset toward the right side for a predetermined distance, and the length of the other magnet 2413 disposed along the second direction is shortened for a predetermined length, such novel design can let the electromagnetic driving forces provided by the AF driving device to achieve a balanced status, no tilts will occur. That is, just because these magnets 241a, 241b, 2413 are asymmetrically disposed on the left and right sides of the second axial plane (YZ) across the lens, the balancing of the AF driving forces can be obtained.

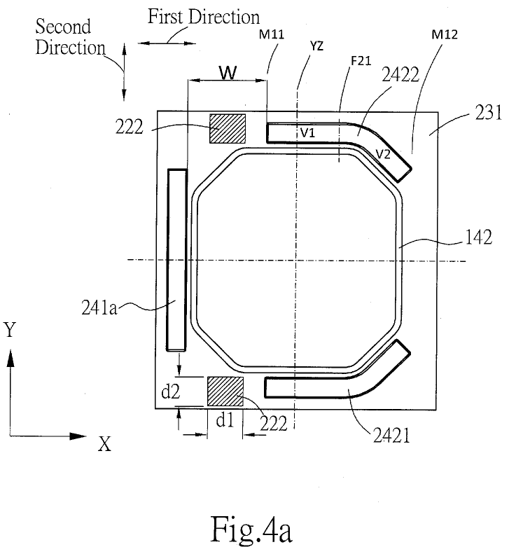

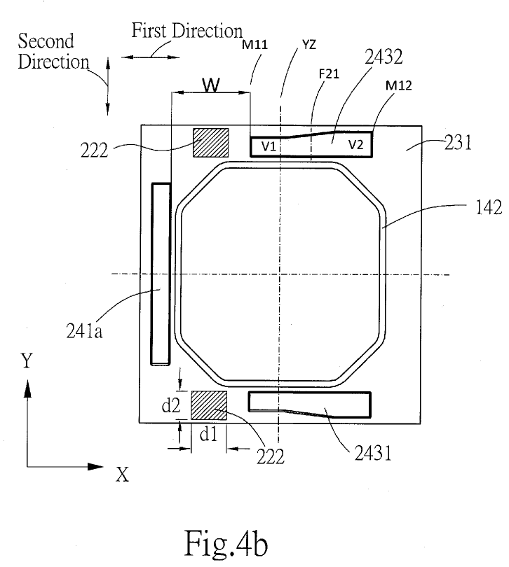

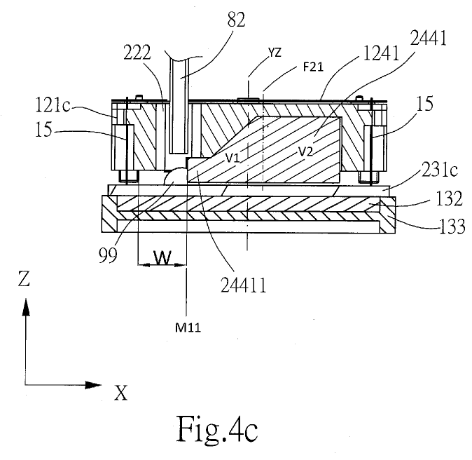

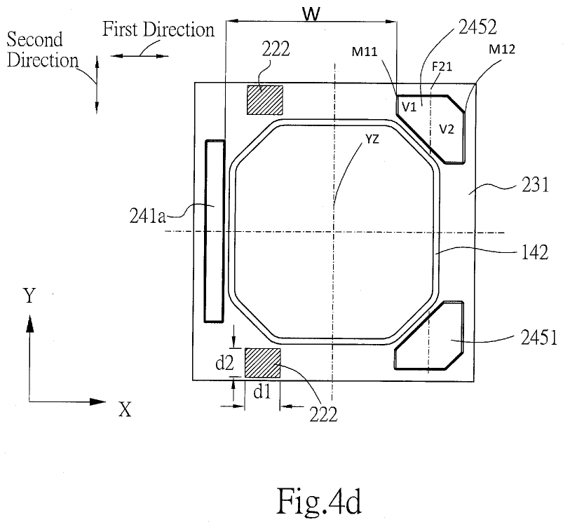

Please refer to FIG. 4a and FIG. 4b, which respectively are the schematic top views of the fourth and the fifth embodiments of the lens driving device with OIS system in accordance with the invention, in which, configuration of the magnets is schematically shown. The characteristic of the fourth embodiment of lens driving device with OIS system in accordance with the invention as shown in FIG. 4a is that, the distances between the second axial plane (YZ) and two ends of the magnets 2421, 2422 disposed along the first direction are different; in addition, the center points of the magnets 2421, 2422 disposed along the first direction are not located at the second axial plane (YZ), and are displaced toward right side by a predetermined distance, so as to leave two gaps (that is, the predetermined width W) respectively disposed between the two ends of the magnets 241a disposed along the second direction and the left ends of the two magnets 2421, 2422 disposed along the first direction. For the magnets 2421, 2422 which are located and extending along the first direction, the center point between two ends in the length direction of each magnet 2421 (or 2422) is defined with a virtual plane F21 which is parallel to the second axial plane (YZ). The virtual plane F21 does not overlap with the second axial plane (YZ). If the magnets 2421, 2422 disposed along the first direction are virtually divided into two parts along the virtual plane F21, then the volumes of these two divided parts will be different; in which, the part near to the second axial plane (YZ) is smaller than the other part away from the second axial plane (YZ). More specifically speaking, a virtual plane F21 which is parallel to the second axial plane (YZ) is defined at the center point between two ends in the length direction of each one of the magnets 2421, 2422 disposed along the first direction. If the magnets 2421, 2422 disposed along the first direction are divided into two parts along the virtual plane F21, then the volumes of these two divided parts will be respectively volume V1 for the left part and volume V2 for the right part. The volume V1 of the part near to the notch 222 is smaller than the volume V2 of the other part away from the notch 222, in addition, the structure of each magnet 2421, 2422 is shaped like a bent tile magnet structure. By means of the displacement of the magnets 2421, 2422, that is, to allow the magnets 2421, 2422 disposed along the first direction to be displaced toward right side, and the configuration of the bent tile magnet structures thereof, the frame 231 of the lens driving device can have sufficient width W to furnish the notches 222 at areas between the left ends of the magnets 2421, 2422 disposed along the first direction and two ends of the other magnet 241a disposed along the second direction, for conducting the applying and curing processes of the damping medium. In addition, such novel structures of bent and displaced tile magnets 2421, 2422 can let the electromagnetic driving forces provided by the AF driving device to achieve a balanced status, as well as to provide more spaces for furnishing the notches. The configuration of bent and displaced tile magnets 2421, 2422 including two parts virtually divided by the virtual plane F21, in which, the volume V2 of the right part away from the notch 222 is larger than the volume V1 of the left part nearby the notch 222, and the right part of each magnet 2421, 2422 is bent as a tile having the inner surface thereof approaching the focusing coil 142 as shown in FIG. 4a. The surrounding structure and contour of the focusing coil 142 is also corresponding to the structure of the bent tile magnets 2421, 2422, which can reduce the distance and thus increase the reaction range between the focusing coil 142 and the bent tile magnets 2421, 2422, so as to generate larger magnetic field to balance the autofocusing driving forces to the lens, and to minimize the tilt angle of the lens during the autofocusing operations caused by the asymmetrically configuration of magnets 241a, 2421, 2422.

The characteristic of the fifth embodiment of lens driving device with OIS system in accordance with the invention as shown in FIG. 4b is that, the configuration of asymmetric volumes (V1, V2) of the magnets 2431, 2432 is achieved by changing their thicknesses in the second direction, such that, the thickness in the second direction of the V2 part (right part) of each magnets 2431, 2432 is thicker than the thickness of the V1 part (left part), which results in the volume of the V2 part (right part) to be larger than the V1 part (left part) of each magnets 2431, 2432 disposed along the first direction. By using the larger (thicker) V2 part (right part) of each magnet 2431, 2432 to generate larger magnetic reaction force to balance the autofocusing driving forces, so as to minimize the tilt angle of the lens during the autofocusing operations caused by the asymmetrically configuration of magnets 241a, 2431, 2432.

Please refer to FIG. 4c, which is the schematic sectional view of the sixth embodiment of the lens driving device with OIS system in accordance with the invention; the characteristic is that: when viewing the sectional view parallel to the first axial plane (XZ), the length of the bottom edge (i.e., the edge nearby the horizontal coil and circuit board 231c) of the magnet 2441 disposed along the first direction is larger than the length of the top edge thereof away from the horizontal coil and circuit board 231c, and the magnet 2441 is formed with an extending portion 24411 at an end nearby the notch 222. The extending portion 24411 of the magnet 2441 and the notch 222 of the frame 121c are partially overlapped in such a manner that, the damping medium 99 applied at the bottom end of the notch 222 will connect to both the extending portion 24411 of the magnet 2441 and the top surface of the circuit board 231c. More specifically speaking, each magnet 2441 disposed along the first direction not only is offset toward the right side for a predetermined distance, but also the projection of the magnet 2441 projected on the first axial surface (XZ plane) shows that, the length of the bottom edge (the edge nearby the horizontal coil) of the magnet 2441 is larger than the length of the top edge (the edge away from the horizontal coil) thereof. The magnet 2441 is formed with an extending portion 24411 at its left end which is partially overlapped with the notch 222 of the frame 121c. The needle 82 of the damper applying equipment 81 applies the damping medium 99 via the notch 222 to connect the extending portion 24411 of the magnet 2441 and the top surface of the circuit board 231c to simplify the damper applying process. The distances between the second axial surface (YZ) and two ends (left end and right end) of the magnet 2441 disposed along the first direction are different. A predetermined width W is defined between the left end (the end which is near to the second axial surface (YZ)) of the magnet 2441 disposed along the first direction and the inner surface of an adjacent magnet disposed along the second direction. The center point between two ends in the length direction of the magnet 2441 is defined with a virtual plane F21 which is parallel to the second axial plane (YZ). If the magnet 2441 disposed along the first direction is virtually divided into two parts along the virtual plane F21, that is, the left part with volume V1 and the right part with volume V2, then the volume V2 of right part is larger than the volume V1 of left part. The end of the magnet 2441 whose distance from the second axial surface is smaller is also the part of the magnet 2441 whose volume V1 is smaller. By using the larger (higher) V2 part (right part) of each magnet 2441 to generate larger magnetic reaction force to balance the autofocusing driving forces, so as to minimize the tilt angle of the lens during the autofocusing operations caused by the asymmetrically configuration of magnets.

Please refer to FIG. 4d, which is the schematic sectional view of the seventh embodiment of the lens driving device with OIS system in accordance with the invention, in which, configuration of the magnets is schematically shown. The polar directions of magnets 241a, 2451, 2452 have the same polarity facing toward the focusing coil 142 which is wound around the outer periphery of the lens (lens support). There is a predetermined width W defined at an area between an inner surface of the magnet 241a disposed along the second direction and the left end (the end near to the second axial surface) of each magnet 2451, 2452 disposed along the first direction. The characteristic of the seventh embodiment shown in FIG. 4d is that, at least one of the magnets 2451, 2452 is not passed by the second axial surface. More specifically speaking, the magnets 2451, 2452 disposed along the first direction substantially are corner magnets 2451, 2452 located at two adjacent corners away from the magnet 241a disposed along the second direction of the frame 231. The center point between two ends in the first direction of each corner magnets 2451, 2452 is defined with a virtual plane F21 which is parallel to the second axial plane (YZ). If the magnet 2451, 2452 is virtually divided into two parts along the virtual plane F21, that is, the left part with volume V1 and the right part with volume V2, then the volume V2 of right part is larger than the volume V1 of left part. Larger predetermined width W can be obtained for furnishing the notches 222 for applying and curing the damping medium by employing the balancing arrangement of magnetic fields of the auto-focusing driving forces disclosed in this seventh embodiment.

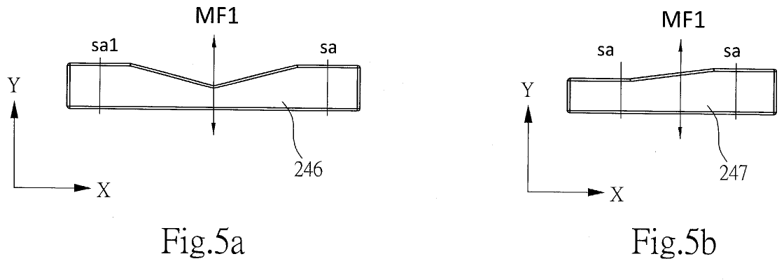

Please refer to FIG. 5a and FIG. 5b, which respectively are the schematic top views (overlooking along the optical axis) of two different embodiments of the magnet of the lens driving device with OIS system in accordance with the invention. As shown in FIGS. 5a and 5b, the sizes and directions of magnetic fields of the magnets 246, 247 can be modified by changing the configurations of the magnets 246, 247. In the prior arts, when electric currents are applied to the horizontal coils located below the magnets 246, 247, the horizontal coils generate magnetic fields and interact with the magnetic fields of the magnets 246, 247 to produce a horizontal driving forces along the magnetic direction MF1, and thus drive the magnets 246, 247 together with the frame to move in the Y-axis direction (magnetic direction MF1). However, once the magnets 246, 247 are moved, the projection of a portion of the magnet 246, 247 in the Z-axis will also shift away from the horizontal coil, causing the changes of the subsequent horizontal driving forces, and thus making the horizontal driving forces less linear. As shown in FIGS. 5a and 5b, in the present invention, through the different configurations of the magnets 246, 247, especially in the Z-axis (optical axis) projection, the thickness of the magnet 246, 247 (i.e., the thickness in the Y-axis direction) will change along the X-axis direction. Therefore, even when a current is applied to the horizontal coil to drive the magnet 246, 247 to move along the Y-axis direction (magnetic direction MF1), and to result that the projection of a portion of the volume of the magnet 246, 247 in the Z-axis direction is shifted away from the range of the horizontal coil, the best linear performance of horizontal driving forces can still be maintained. Less magnets 246, 247 are configured to provide larger spaces for furnishing the notches for applying and curing the damping medium, while the electromagnetic autofocus driving forces can also be balanced. The magnetic field of the horizontal coil applied with current reacts with the MF2 magnetic field perpendicular to the magnetic direction MF1 of the magnet 246, 247 to generate electromagnetic driving forces, and the balance of the driving forces is obtained by means of the configuration and offset arrangement of the magnet 246, 247. The volumetric asymmetric configuration of the magnet 246, 247 of the lens driving device provides a myriad of different magnetic flux densities to react with the horizontal coil. In the condition that the density of coils wounded of the horizontal coil is kept constant, sufficient horizontal driving force and optimal linear performance can be achieved by means of the offset in position and volumetric asymmetrical configuration of the magnets 246, 247.

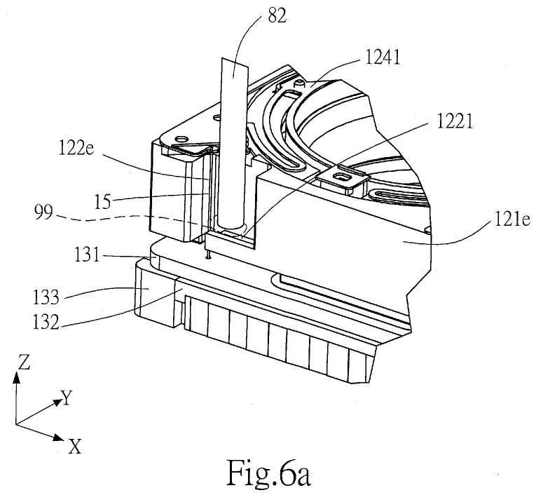

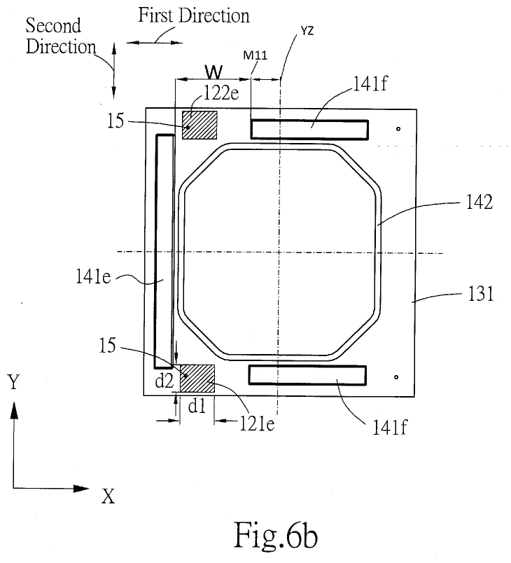

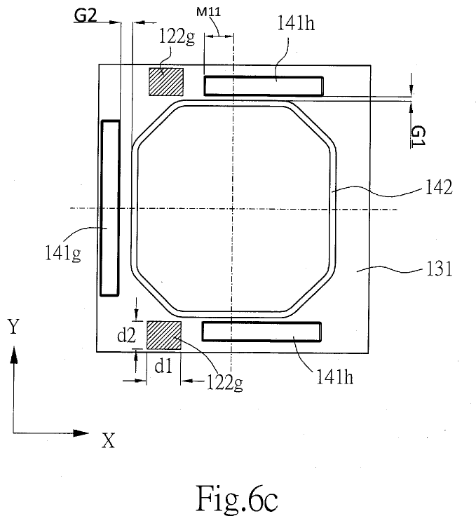

Please refer to FIG. 6a, which is a schematic perspective view (applying the damping medium) of the eighth embodiment of the lens driving device with OIS system in accordance with the present invention. The difference between the eighth embodiment shown in FIG. 6a and the first embodiment shown in FIG. 2c is that, in the eighth embodiment shown in FIG. 6a, the position of the notch 122e overlaps with one of the suspension wires 15; in other words, the suspension wire 15 extends in the notch 122e along the Z-axis direction. The suspension wire 15 is located in a predetermined width between the plurality of magnets and is connected with the spring plate 1241 for supporting and suspending the lens and the frame 121e above the base 133 via the notch 122e formed on the frame 121e. A groove 1221 is formed at the bottom end (the end nearby the base 133) of the notch 122e of the frame 121e. One side of the groove 1221 is formed with a through hole to allow the suspension wire 15 to pass through. The damping medium 99 is applied at the groove 1221 of the notch 122e in such a manner that, a portion of the damping medium 99 attaches to (sticks to) a lower portion (e.g., below the ½ length) of the suspension wire 15, another portion of the damping medium 99 attaches to (sticks to) the groove 1221 and the frame 121e.

Please refer to FIG. 6b, which is a schematic top view of the ninth embodiment of the lens driving device with OIS system in accordance with the present invention, in which, configuration of the magnets is schematically shown. As shown in FIG. 6b, the magnet 141e disposed along the second direction (Y-axis direction) is longer than (that is, both the upper and lower ends of the magnet 141e are extending farer than) the inner surface (nearby the lens) of the adjacent magnets 141f disposed along the first direction. There is a predetermined width W defined at an area between an inner surface of the magnet 141e disposed along the second direction and the left end (the end near to the second axial surface YZ) of each magnet 141f disposed along the first direction. At least one suspension wire 15 is passing through the predetermined width W, and the notch 122e is located right at the location where the suspension wire 15 is passing. By means of the offset arrangement of the magnet 141f disposed along the first direction and the extending (longer) configuration of the other magnet 141e disposed along the second direction, sufficient and balanced driving forces for both autofocusing axial driving force and horizontal OIS driving forces can be obtained, and more spaces are provided for furnishing the notches 122e for applying and curing the damping medium.

Please refer to FIG. 6c, which is a schematic top view of the tenth embodiment of the lens driving device with OIS system in accordance with the present invention, in which, configuration of the magnets is schematically shown. As shown in FIG. 6c, the three magnets 141g, 141h are all unipolar magnet, having the same polarity facing toward the focusing coil 142 which is wound around the outer periphery of the lens (lens support). The gap between the focusing coil 142 and the magnet 141g disposed along the second direction (Y-axis direction) is larger than the gap between the focusing coil 142 and other two magnets 141h disposed along the first direction (X-axis direction). The notches 122g are located between the left end of the two magnets 141h disposed along the first direction and the upper and lower ends of the magnet 141g disposed along the second direction. The horizontal coils applied with currents react with the magnets 141h disposed along the first direction and the magnet 141g disposed along the second direction to generate the horizontal driving forces, in order to drive the movable part of the lens driving device to move horizontally relative to the image sensor located below the base. By configuring different size of gaps between the focusing coil 142 and the magnets 141g, 141h, the tilt angle of the lens during the autofocusing operations caused by the asymmetrically configuration of magnets 141g, 141h can be minimized, while more spaces can also be provided for furnishing the notches 122g for applying and curing the damping medium.

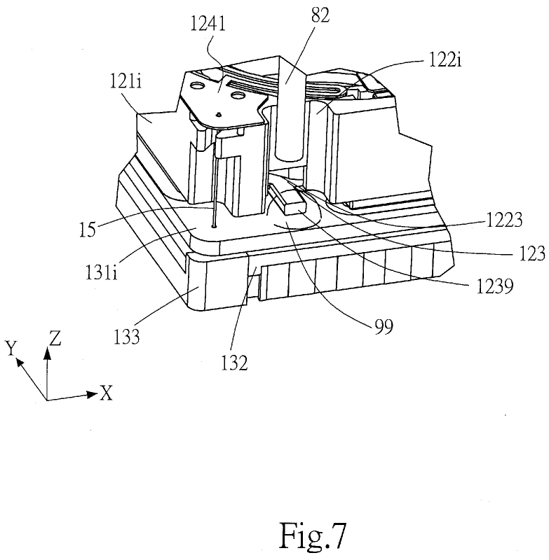

Please refer to FIG. 7, which is a schematic perspective view (applying the damping medium) of the eleventh embodiment of the lens driving device with OIS system in accordance with the present invention. The difference between the eleventh embodiment shown in FIG. 7 and the first embodiment shown in FIG. 2c is that, in the eleventh embodiment shown in FIG. 7, a protrude 1239 is formed at the bottom side of the lens support 123 and is extending into the bottom end of the notch 122i. The applied damping medium 99 is attaching the protrude 1239 of the lens support 123 and the top surface of the circuit board 131i. More specifically speaking, the needle 82 of the damper applying equipment 81 can directly pass through the notch 122i from the top surface of the frame 121i and apply the damping medium 99 to connect the protrude 1239 formed at the bottom side of the lens support 123 and the the circuit board 131i of the fixed part. The notch 122i of the frame 121i includes an opening 1223, which provides sufficient space for the protrude 1239 of the lens support 123 to move along the focusing and horizontal directions. The damping medium 99 is applied directly on the protrude 1239 of the lens support 123 of the movable part and the circuit board 131i of the fixed part, such that the shaking occurred in the lens driving device during operation can be more directly stabilized. By furnishing the notches 122i on the frame 121i, the dumping medium 99 can be directly applied and cured at predetermined locations more easily. The advantage of such design is that, the dumping medium 99 attaches to both the protrude 1239 of the lens support 123 and the circuit board 131i can provide damping function in all of the three axial directions (X-axis, Y-axis and Z-axis).

While the present invention has been particularly shown and described with reference to a preferred embodiment, it will be understood by those skilled in the art that various changes in form and detail may be modified without departing from the spirit and scope of the present invention.

What is claimed is:

1. A lens driving device with optical image stabilization system, defining an optical axis and comprising:
a fixed part;
a movable part, which comprises a frame and a lens support located inside the frame;
a suspension mechanism, for suspending the movable part above the fixed part in such a manner that, the movable part can perform limited displacements relative to the fixed part; and
a driving system, for at least driving the frame of the movable part to move relative to the fixed part along a horizontal direction; said horizontal direction is perpendicular to the optical axis;
wherein, the characteristics of the lens driving device comprise:
the frame is furnished with at least one notch; the notch extends downward along the optical axis from an upper surface of the frame in such a manner that, a bottom of the notch is the location where a damping medium is applied, in addition, the damping medium attaches the movable part and one of the suspension mechanism and the fixed part.

2. The lens driving device of claim 1, wherein a needle of a damper applying equipment can penetrate the notch in a top-to-bottom manner and then apply said damping medium at the bottom of the notch; in addition, a medium curing equipment can apply curing light directly from a top side of the lens driving device for curing the damping medium via the notch; a part of the damping medium connects the frame of the movable part, while another part of the damping medium connects either a circuit board or a base of the fixed part.

3. The lens driving device of claim 1, wherein:
the fixed part comprises a base;
the lens support is for holding a lens, said optical axis is defined by the lens;
the lens support is received inside the lens support and is movable along the optical axis in a limited manner;
the movable part further comprises at least one spring plate which elastically connects the frame and the lens support;
the suspension mechanism comprises a plurality of suspension wires connecting between the base and the frame.

4. The lens driving device of claim 3, wherein, the lens driving device further defines an X-axis, a Y-axis and a Z-axis perpendicular with each other; the optical axis is parallel to the Z-axis; the X-axis and the Z-axis define a first axial surface; the Y-axis and the Z-axis define a second axial surface; the optical axis overlaps the Z-axis and is located on the intersection axis of the first and second axial planes; a direction of X-axis is called as a first direction; another direction of Y-axis is called as a second direction;
the fixed part further comprises a circuit board and a connecting board; the circuit board is connectable with an external circuit via the connecting board; the external circuit is furnished with an image sensor;
the driving system comprises: at least one focusing coil, at least two horizontal coils furnished on the circuit board, and a plurality of magnets furnished in the frame; wherein, the focusing coil is located on an outer periphery of the lens support and is corresponding to the magnets furnished in the frame; said horizontal coils are respectively corresponding to the magnets;
the plurality of magnets are disposed along either the first direction or the second direction;
for the magnet which is disposed along the first direction, a center point between two ends of the magnet is defined with a virtual plane which is parallel to the second axial plane; the virtual plane does not overlap with the second axial plane;
among the plurality of magnets, at least two adjacent magnets are separated by a predetermined width which is larger than a width of the notch; the notch is formed on the frame and is located at the predetermined width.

5. The lens driving device of claim 4, wherein, the notch is located on the frame and is located at an end of the magnet disposed along the first direction;
wherein, said end of the magnet where the notch is located is nearer to the second axial plane than the other end of the magnet.

6. The lens driving device of claim 4, wherein, the magnets disposed along the second direction are asymmetrically disposed on the left and right sides of the second axial plane across the lens.

7. The lens driving device of claim 4, wherein, when the magnets disposed along the first direction are virtually divided into two parts along the virtual plane, the volumes of these two divided parts will be different, in which, the part near to the second axial plane is smaller than the other part away from the second axial plane.

8. The lens driving device of claim 4, wherein, when viewing a sectional view parallel to the first axial plane, a length of a bottom edge of the magnet disposed along the first direction is larger than a length of a top edge of the same magnet away from the horizontal coil; in addition, the magnet is formed with an extending portion at an end nearby the notch; the extending portion of the magnet and the notch of the frame are partially overlapped in such a manner that, the damping medium applied at the bottom of the notch can connect to both the extending portion of the magnet and the circuit board.

9. The lens driving device of claim 4, wherein, a width of the notch along the first direction and another width of the notch along the second direction are both larger than 0.3 mm and smaller than 0.8 mm; the predetermined width where said at least two adjacent magnets are separated is larger than 0.8 mm and smaller than 3 mm.

10. The lens driving device of claim 4, wherein, the damping medium is connecting a bottom surface of the frame and the circuit board.

11. The lens driving device of claim 4, wherein, a protrude is formed at a bottom side of the lens support and is extending into the bottom of the notch; the applied damping medium is attaching the protrude of the lens support and the circuit board.

12. The lens driving device of claim 4, wherein, at least one of the suspension wires is extending inside the notch along a direction parallel to the Z-axis; a groove is formed at the bottom of the notch of the frame; the groove is formed with a through hole to allow the suspension wire to pass through; the damping medium is applied at the groove of the notch in such a manner that, a portion of the damping medium attaches to a lower portion of the suspension wire, while another portion of the damping medium attaches to the groove.

13. The lens driving device of claim 4, wherein, a gap between the focusing coil and the magnet disposed along the second direction is larger than another gap between the focusing coil and the magnet disposed along the first direction.

14. The lens driving device of claim 4, wherein, when viewing a projection of the magnet along the Z-axis direction, a thickness in the Y-axis direction of the magnet will change along the X-axis direction; therefore, even when a current is applied to the horizontal coil to drive the magnet to move along the Y-axis direction, and to result that a projection of a portion of the volume of the magnet in the Z-axis direction is shifted away from a range of the horizontal coil, a linear performance of horizontal driving force can still be maintained.
